(19) United States
(12) Patent Application Publication
(10) Pub. No.: US 2017/0003985 A1
(43) Pub. Date: Jan. 5, 2017

(54) PROCEDE DE CONFIGURATION ET PROCEDE DE COMMANDE D'UN SYSTEME DE MODULES D'EXECUTION INTERCONNECTES

(71) Applicant: ANTHEMIS TECHNOLOGIES, VALENCE (FR)

(72) Inventor: Patrice MARSANNE, SAINT PERAY (FR)

(21) Appl. No.: 15/197,607

(22) Filed: Jun. 29, 2016

(30) Foreign Application Priority Data
Jul. 1, 2015 (FR) 15/56190

(51) Int. Cl. G06F 9/445; G06F 13/42; G06F 9/455

(52) U.S. Cl. CPC G06F 9/44505; G06F 9/45545; G06F 13/4282; G06F 2009/45595

(57) ABSTRACT

A method for configuring and controlling a system of interconnected execution modules as well as a system of interconnected execution modules including a multitude of execution modules includes at least one configuration interface arranged so as to define at least one user program including at least one operation rule, and at least two execution modules among the multitude of execution modules. At least one first execution module is arranged so as to interpret and execute the at least one user program and at least one second execution module is arranged so as to communicate with the at least one first execution module via a communication interface. The method includes at least one operation rule defining at least one operation to be carried out based on at least one condition determined on the basis of a variable representative of a functioning state or a measurement of a physical quantity.

### TECHNICAL FIELD

The present disclosure relates to a method for configuring and to a method for controlling a system of execution modules. The present disclosure further concerns a system of interconnected execution modules.

### BACKGROUND

It is known in the state of the art to make apparatuses in the form of modules function by a mechanical assembly of several modules having different functions, the configuration of the assembly of said modules defining the overall functionality of the system. The flexibility of such a system is limited and does not allow the execution of complex operations.

The present disclosure aims to solve all or part of the aforementioned drawbacks.

### SUMMARY

To this end, the present disclosure concerns a method for configuring a system of interconnected execution modules, each of the execution modules of the system of execution modules including a virtual machine and at least one actuator and/or one sensor and/or one user interface and/or one data processing system, comprising the following steps:

providing a state reference system of the system of interconnected execution modules, indicating a nature of each of the execution modules, a state of each of the execution modules on the basis of a variable representative of a functioning state of the at least one execution module or a measurement of a physical quantity by a sensor of the at least one execution module, and at least one connection between the execution modules;

providing a user macro-program comprising at least one user program;

defining at least one user program of the user macro-program executable on a determined execution module comprising at least one operation rule defining at least one operation to be carried out, the realization of said at least one operation corresponding to the generation of a control command toward an actuator and/or a user interface and/or a data processing system of this execution module, and/or toward at least one execution module of the system of interconnected execution modules;

sending the at least one user program toward at least one determined execution module via at least one communication link, the at least one execution module being arranged so as to execute the user program.

Thanks to the arrangements according to the disclosure, the at least one user program may be sent to the at least one execution module and executed upon receipt by said execution module, thanks to the virtual machine. In particular, the virtual machine allows the immediate execution of an operation rule received during a functioning period of the system of execution modules. By immediate execution of an operation rule, is meant an execution carried out upon receipt of the operation rule by the at least one execution module. The operation rule is interpreted and then executed upon its receipt by the at least one execution module.

Thus, the system of execution modules is flexible and can adapt to a change of the user macro-program. It is not necessary to re-program or restart the system of execution modules in order that the execution modules execute a modified user program.

Thanks to these arrangements, the system does not require any connection to the Internet network.

Furthermore, these arrangements allow lightening the occupancy of the network, because only the useful informations are transmitted. Thus, the reactivity of the system of modules is improved, and the energy consumption is thus reduced. Furthermore, this functioning allows lightening the calculation load on the different execution modules by distributing it.

According to one aspect of the disclosure, the operation is carried out based on at least one condition determined by a configuration interface or by a control command from at least one execution module of the system of execution modules on the basis of a value of the variable representative of a functioning state of at least one execution module of the system of execution modules, or of a measurement of a physical quantity by a sensor of at least one execution module.

According to one aspect of the disclosure, the at least one execution module is arranged so as to assess the realization of the at least one condition of the at least one operation rule based on the at least one value of the representative variable, and to carry out the at least one operation based on the assessment of the realization of the at least one condition.

A condition defines a test criterion corresponding to an operation having to be carried out when the test criterion of the condition is met. In particular, the test criterion may be defined based on representative variables.

According to one aspect of the disclosure, the at least one operation is carried out on receipt of local data or based on data from at least one execution module of the system of interconnected execution modules.

According to one aspect of the disclosure, the at least one execution module is arranged so as to assess the realization of the at least one operation by the data processing system.

According to one aspect of the disclosure, the data processing system is ensured by an electronic control unit.

According to one aspect of the disclosure, the configuration method comprises a step of defining a state of the system of execution modules, in which determined execution modules are activated and determined communication links are defined.

According to one aspect of the disclosure, the configuration method comprises a step of defining at least one user program.

According to one aspect of the disclosure, at least one user program is defined in a source code.

According to one aspect of the disclosure, the configuration method comprises a step of generating the at least one user program in an intermediate code, from the source code. By intermediate code, is meant a code independent from an execution module or from any material platform. More particularly, by intermediate code, is meant a program compiled in a code executable by a virtual machine, for example the <<bytecode>>.

More particularly, the configuration method comprises a step of compiling the at least one user program in an intermediate code from the source code.

According to one aspect of the disclosure, the at least one user program is sent toward the at least one execution module in the form of source code and intermediate code.

Thanks to the arrangements according to the disclosure, the source code of the program intended to the at least one module is stored in said execution module.

Thus, a user who does not have access to a terminal having been used for defining a user program, can access to the source code by requesting it from the at least one execution module, and thus modify the user program. Thanks to these arrangements, the system of execution modules is flexible and its use is facilitated.

Furthermore, the use of a virtual machine frees from constraints related to the choice of the language used for the source code. Indeed, the source code is compiled in an intermediate code executable by the virtual machine regardless of the language used for the source code.

According to one aspect of the disclosure, the configuration method comprises at least one step of configuring a control interface in which the correspondence is defined between at least one interface interaction and the determination of the at least one condition and/or of the at least one operation.

According to one aspect of the disclosure, the configuration method comprises a step in which, subsequently to an interface interaction, a modified user program is sent toward the at least one execution module.

According to one aspect of the disclosure, the configuration method comprises a step of implementing a wireless communication thanks to a portal module between the configuration interface and the at least one execution module or still between two execution modules of the system of execution modules.

According to one aspect of the disclosure, the wireless communication is implemented by a wireless communication protocol of the type complying with the standard IEEE 802.11/WIFI.

According to one aspect of the disclosure, the configuration method comprises a step of implementing a wireless connection thanks to a portal module between the system of execution modules and an external system of execution modules.

According to one aspect of the disclosure, the wireless communication is implemented by a wireless communication protocol of the WIFI type, or of the type complying with the UMTS network standard or of a type complying with any other network standard.

The present disclosure further concerns a method for controlling at least one execution module of a system of interconnected execution modules, the at least one execution module including at least one actuator and/or one sensor and/or one user interface and/or one data processing system, comprising the following steps:

A. providing at least one user program comprising at least one operation rule defining at least one operation to be carried out, the realization of said at least one operation corresponding to the generation of a control command toward an actuator and/or a user interface and/or a data processing system of this execution module, and/or toward at least one execution module of the system of interconnected execution modules; then

B. executing the at least one user program.

According to one aspect of the disclosure, the operation is carried out based on at least one condition determined by a configuration interface or by a control command from at least one execution module of the system of execution modules on the basis of a value of the variable representative of a functioning state of at least one execution module of the system of execution modules, or of a measurement of a physical quantity by a sensor of at least one execution module.

According to one aspect of the disclosure, the step B comprises the following substeps:
assessing the realization of the at least one condition of the at least one operation rule based on the at least one value of the representative variable; then
carrying out the at least one operation based on the assessment of the realization of the at least one condition.

According to one aspect of the disclosure, the at least one operation is carried out on receipt of local data or based on data from at least one execution module of the system of interconnected execution modules.

According to one aspect of the disclosure, the at least one execution module is arranged so as to assess the realization of the at least one operation by the data processing system.

The present disclosure also concerns a system of interconnected execution modules including a multitude of execution modules, each comprising an electronic control unit, the system of interconnected execution modules further comprising:
at least one configuration interface arranged so as to define at least one user program including at least one operation rule;
at least one first execution module among the multitude of execution modules arranged so as to interpret and execute the at least one user program;
at least one second execution module among the multitude of execution modules arranged so as to communicate with the at least one first module via a communication interface;
the at least one operation rule defining at least one operation to be carried out, and
the realization of said at least one operation corresponding to the generation of a control command toward the actuator and/or the user interface of the at least one first execution module and/or the at least one second execution module.

According to one aspect of the disclosure, the operation is carried out based on at least one condition determined on the basis of the variable representative of a functioning state or of a measurement of a physical quantity by a sensor of the at least one first and/or the at least one second execution module among the multitude of execution modules.

According to one aspect of the disclosure, the system of execution modules comprises a portal module allowing sending and/or receiving data toward and/or from the system of execution modules.

According to one aspect of the disclosure, the portal module is arranged so as to interpret and execute at least one user program.

According to one aspect of the disclosure, the at least one first execution module and the at least one second execution module comprise an interpreter, arranged so as interpret at least one user program.

### BRIEF DESCRIPTION OF THE DRAWINGS

Other features and advantages of the present disclosure will appear in the light of the description that will follow and upon examination of the appended figures, in which:

FIG. 1 represents the general architecture of the system of execution modules;

FIG. 2 represents a programmer interface;

FIG. 3 represents a control interface editor;

FIG. 4 represents a control interface;

FIG. 5 represents the functioning of an execution module; and

FIG. 6 represents a method for configuring the system of execution modules.

### DETAILED DESCRIPTION OF THE DRAWINGS

In all these figures, identical or similar reference numerals refer to identical or similar members or sets of members.

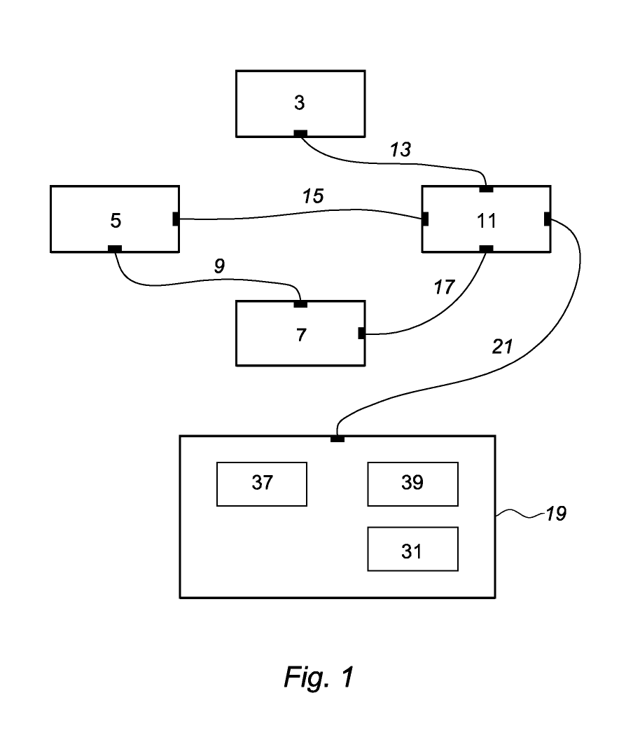

In FIG. 1, there is represented a system of execution modules. In this embodiment, the system of execution modules comprises three execution modules 3, 5, 7. The execution module 3 is, for example, a module comprising a temperature sensor, the execution module 5 is, for example, an actuator module of a fan and the execution module 7 is, for example, an actuator module of a LED. The execution modules 5 and 7 communicate thanks to a communication interface 9. In this embodiment, the communication interface 9 implements a wireless communication protocol, for example of the type complying with the standard IEEE 802.11/WIFI.

The execution modules 3, 5, 7 are in the form of cases.

The system of execution modules further comprises a portal module 11. The portal module 11 and the execution modules 3, 5, 7 communicate thanks to the communication links 13, 15, 17 respectively. The portal module 11 allows implementing a wireless communication protocol, for example of the type complying with the standard IEEE 802.11/WIFI.

The portal module 11 may also be used to connect the system of execution modules to another similar system of execution modules.

The system of execution modules further comprises a configuration interface 19.

In this embodiment, the execution modules 3, 5 and 7 communicate with the configuration interface 19 via the portal module 11. The portal module 11 and the configuration interface 19 communicate thanks to a communication link 21.

Each of the execution modules 3, 5, 7, the portal module 11 and the configuration interface 19 comprises an electronic control unit thereby allowing data processing by a data processing system.

According to another embodiment, the execution modules 3, 5, 7 and the configuration interface 19 may communicate directly, without any portal module 11.

The communication link 21 comprises, for example, an interface implementing a wireless communication protocol, for example of the type complying with the standard IEEE 802.11/WIFI, of the type complying with the UMTS network standard or of a type complying with any other network standard.

In particular, the configuration interface 19 may be realized as a Web interface hosted on a server and remotely or locally accessible by a terminal such as a stationary computer or a portable terminal such as a laptop computer, a tablet or a smartphone.

The configuration interface 19 allows the user to configure the system of execution modules. Thus, the configuration interface 19 allows the user to define a user macro-program comprising a set of operation rules.

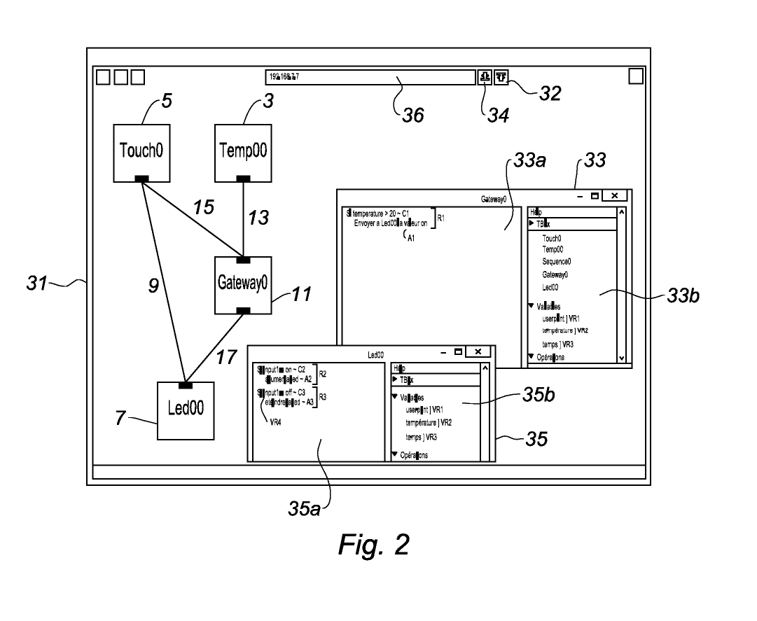

The configuration interface 19 comprises a programmer interface 31, represented in FIG. 2.

The execution modules 3, 5, 7, as well as the portal module 11, appear on the programmer interface 31. The programmer interface 31 allows selecting either one of the execution modules 3, 5, 7 or the portal module 11 in order to access to a programming window proper to each execution module 3, 5, 7 or to the portal module 11. For example, in FIG. 2, a window 33 corresponding to the portal module 11, referred to as <<Gateway0>>, is open. A window 35 corresponding to the execution module 7, referred to as <<Led00>>, is also open.

Each of the windows 33, 35 comprises a first pane 33a, 35a respectively, in which the user can define a user program comprising operation rules, thanks to a text editor.

The pane 33a allows defining operation rules regarding the portal module 11. The pane 35a allows defining operation rules regarding the execution module 7.

Each of the windows 33, 35 also comprises a second pane 33b, 35b respectively, herein referred to as <<Help>>. Each of the second panes 33b, 35b comprises a drop-down menu referred to as <<TBrix>> allowing selecting either one of the execution modules 3, 5, 7 or the portal module 11 about which the user desires defining an operation rule.

The second panes 33b, 35b further comprise a drop-down menu referred to as <<Variables>>, allowing selecting a representative variable about which the user desires defining an operation rule.

For example, a first representative variable VR1 is referred to as <<input1>>, and is intended to be defined by the user. The representative variable VR1 may correspond to a functioning state of an execution module, for example to the functioning state of the execution module 5, actuator of a fan or of the execution module 7, actuator of a LED. A functioning state of the execution module 5 or of the execution module 7 may be either the on state or the off state.

A second representative variable is, for example, referred to as <<temperature>>, and corresponds to measurements of physical quantities carried out by the execution module 3 temperature sensor.

According to other embodiments, the representative variables may correspond to measurements of physical quantities carried out by other types of sensors, for example, brightness sensors, humidity sensors, etc.

A third representative variable VR3 is, for example, referred to as <<time>>, and corresponds to measurements of physical quantities carried out by a clock or by a chronometer.

The second panes 33b, 35b also comprise a drop-down menu referred to as <<Operations>>, allowing selecting a pre-programed operation to be executed based on a condition defined by the user.

Pre-programmed operations may have been programmed prior to the configuration of the system of execution modules by the user. Pre-programmed operations may have been programmed by the manufacturer of the system of execution modules prior to its sale. Pre-programmed operations may be obtained from a download from a network, for example, the Internet network.

Thus, the user may define operation rules.

In FIG. 2, three examples of operation rules R1, R2, R3 have been described. An operation rule, for example the operation rule R1, comprises a condition C1 defining a test criterion and a corresponding operation A1 having to be carried out when the test criterion of the condition C1 is met. The operation rule R1 is to be applied by the portal module 11.

The operation rules R2 and R3 comprise similar elements referred to later on by the same reference numerals as the elements of R1, the number <<1>> is replaced with the number <<2>> or <<3>> respectively. The operation rules R2 and R3 function in the same manner as the operation rule R1. The operation rules R2 and R3 are to be applied by the execution module 7.

The conditions C1, C2, C3 herein are defined based on a representative variable, on a threshold value to which the representative variable will be compared and on a test criterion.

Each of the operation rules R1, R2, R3 also comprises at least one operation A1, A2, A3 respectively, to be carried out if the conditions C1, C2 or C3 respectively are met.

As example, it is possible to define an operation rule R1 in a simple manner.

The condition C1 is defined by the representative variable VR2, <<temperature>>, that the user has selected in the drop-down menu <<Variables>>, by a threshold value <<20>>, and by the test criterion <<>>>, meaning <<higher>>.

Afterwards, the user may define the operation A1 that he desires to see being carried out when the condition C1 is met.

The user selects an operation to carry out by the portal module 11. In this example, the operation is defined based on the execution module 7, <<Led00>> and based on a variable VR4 representative of the functioning state of the execution module 7.

Hence, the defined operation A1 includes sending the value <<ON>> of the representative variable VR4 to the execution module 7.

Thus, the operation rule R1 may be read <<if the received measurement of temperature carried out by the execution module 3 temperature sensor is higher than the value 20, then send the value ON to the execution module 7>>.

Thus, it is possible to define multiple rules regarding the system of execution modules 3, 5, 7.

In the same manner, the operation rule R2, applied to the execution module 7 is read <<if the received value of the representative variable VR4, referred to as <<input1>>, is equal to <<ON>>, then turn on the LED>>.

In the same manner, the operation rule R3, applied to the execution module 7 is read <<if the received value of the representative variable VR4, referred to as <<input1>>, is equal to <<OFF>>, then turn off the LED>>.

The operation rules R1, R2, R3 may then be sent toward the portal module 11 and the execution modules 3, 5, 7 by the button 32. Afterwards, the portal module 11 may send to each execution module 3, 5, 7 the user program thereof.

A button 34 allows downloading, in the configuration interface, the programs present in the portal module 11 and/or the execution modules 3, 5, 7.

The bar 36 indicates the network address toward which the operation rules are sent, or from which the operation rules, present in the system of execution modules, are downloaded. In this embodiment, it includes the network address of the portal module 11.

The configuration interface 19 further comprises a control interface 37 and a control interface editor 39.

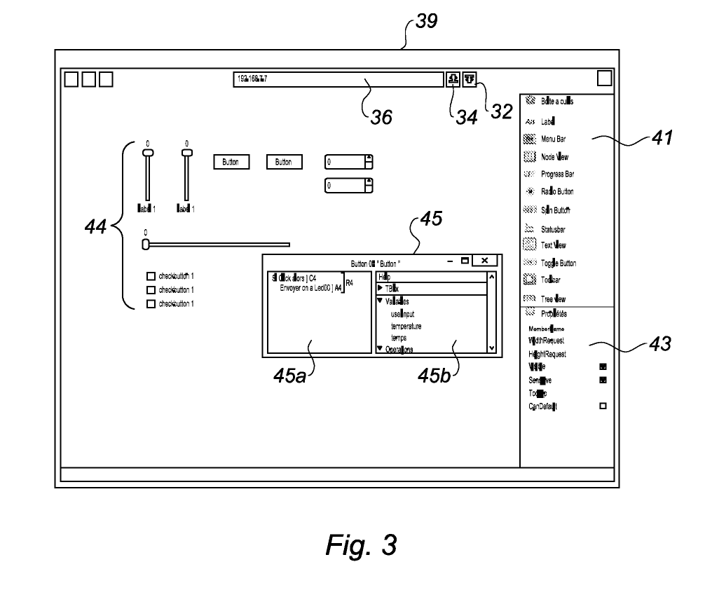

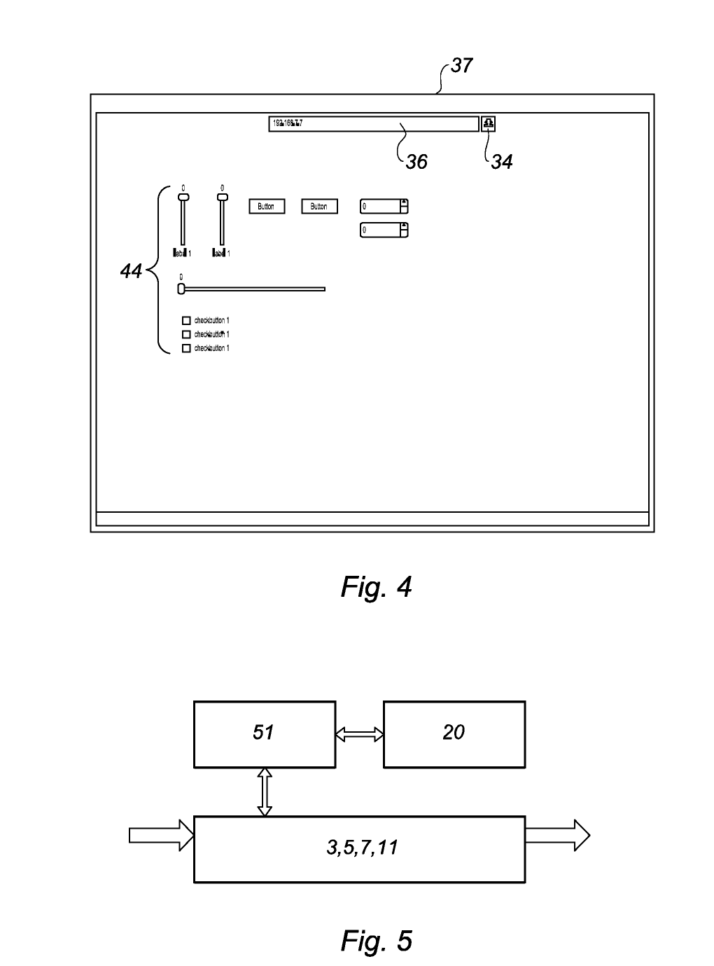

The control interface editor 39 is represented in FIG. 3. The control interface editor 39 comprises a window 41, referred to as <<toolbox>> comprising a type list of interaction elements 44 allowing the user to define the interface interactions. By interaction element, is meant any type of buttons, cursors, etc., with which the user can interact. By interface interaction, is meant an interaction between the user and the control interface. An interface interaction may be, for example, an action of the user by clicking on a button or by displacing a cursor. Hence, the interface interactions are produced between the user and the configuration interface 19 and more particularly the control interface 37, represented in FIG. 4. The interface interactions correspond to the determination and/or to the modification of operation rules by the user.

The control interface editor 39 also comprises a window 43, referred to as <<Properties>>. The window 43 displays the different parameters of an interaction element selected beforehand. The window 43 further allows modifying the parameters of the selected interaction element or still interfacing them with the values derived from the TBRIX.

The control interface editor 39 is arranged so as to program the chosen interaction elements 44.

By selecting an interaction element, it is possible to open a programming window. For example, in FIG. 3, a programming window 45 of the interaction element referred to as <<Button0>> is open. The window 45 comprises a first pane 45a, in which the user can define operation rules regarding the interaction element <<Button0>>. The interaction element <<Button0>> is a button. The pane 45a is similar to the panes 33a and 35a. The definition of the operation rules regarding the interface elements 44 is carried out in the same manner as the definition of the operation rules regarding the execution modules 3, 5, 7.

The window 45 comprises a second pane 45b referred to as <<Help>>, similar to the panes 33b and 35b. The functioning of the second pane 45b is similar to the functioning of the second panes 33b, 35b.

The first pane 45a comprises a user program including an operation rule R4. The operation rule R4 comprises a condition C4 and an operation A4 to be carried out if the condition C4 is met. The operation rule R4 is defined in the same manner as the operation rules R1, R2 and R3.

The condition A4 is defined by an interaction between the user and the configuration interface 19. For example, the condition C4 corresponds to the realization of the interaction <<click>>.

The operation rule R4 is read <<if the interaction <<click>> is carried out, then send the value ON of the representative variable VR4 to the execution module 7>>.

The operation rule R4 may be loaded toward the portal module 11 or either one of the execution modules 3, 5 or 7 by the button 32.

The button 34 allows downloading, in the configuration interface, the preexisting interface definition and the user programs present in the portal module 11 and/or the execution modules 3, 5, 7, thereby allowing editing the control interface.

The bar 36 indicates the network address toward which the operation rules are sent, or from which the operation rules, present in the system of execution modules, are downloaded. In this embodiment, it includes the network address of the portal module 11.

The control interface 37, represented in FIG. 4, comprises the buttons 44 chosen and programed in the control interface editor 39. The buttons 44 of the control interface may also have been programmed beforehand and downloaded from the portal module 11. In another embodiment, the buttons 44 of the control interface may also have been downloaded from either one of the execution modules 3, 5, 7. The buttons 44 allow the user to interact with the system of execution modules.

Thanks to the buttons 44, the user can actually define or modify an operation rule regarding an execution module.

Hence, the configuration interface allows defining at least one user program, composed of operation rules R1, R2, R3, R4 defined in the configuration interface 19.

The configuration interface 19 is displayed on a terminal such as a stationary computer or on a portable terminal such as a laptop computer, a tablet or a smartphone (not represented).

The user macro-program is programmed in a source code, for example in Java or C language.

When sending the user programs toward the portal module 11 and the execution modules 3, 5, 7, the user programs are compiled in an intermediate code. By intermediate code, is meant a code independent from an execution module or from any material platform. More particularly, by intermediate code, is meant a program compiled in a code executable by a virtual machine, for example the bytecode D.

Afterwards, the user programs in the intermediate code are sent toward the portal module 11 and/or the considered at least one execution module 3, 5, 7.

As represented in FIG. 5, each execution module 3, 5, 7 and the portal module 11 executes a virtual machine 51 which, in turn, executes the intermediate code derived from the compilation of the user macro-program.

When an execution module 3, 5, 7 or the portal module 11 receives a user program in an intermediate code, the latter is transmitted toward the virtual machine 51 which executes it, thereby piloting the execution module 3, 5 or 7 or the portal module 11. Thus, the user program in the intermediate code may be replaced, modified during the functioning of the system of execution modules, without the need for restarting or re-programming the considered execution modules 3, 5, 7 and/or the portal module 11.

The use of a virtual machine 51 frees from constraints related to the choice of the language used for the source code. Indeed, the source code is compiled in an intermediate language executable by the virtual machine regardless of the language used for the source code.

Furthermore, the user programs are sent toward the portal module 11 and/or the considered at least one execution module 3, 5, 7, in the source code.

Thus, if a user does not have access to the server on which the user programs have been defined and stored in source code, he will be able, on request, to retrieve the source code from the portal module 11 and/or the considered at least one execution module 3, 5, 7. Thus, the user will be able to modify the user programs. Thanks to these arrangements, the system of execution modules is flexible and its use is facilitated.

Each of the execution modules 3, 5, 7, the portal module 11 and the configuration interface 19 further comprises a micro-processor arranged so as to execute at least one user program thereof.

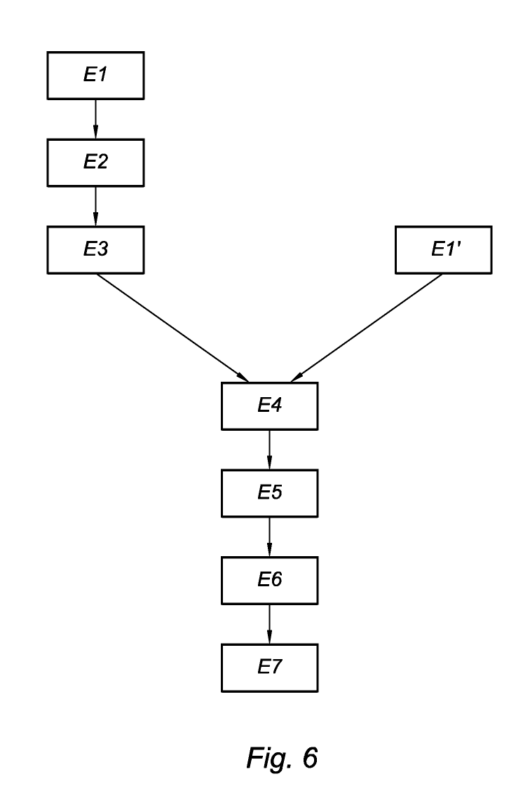

Thus, the use of the system of execution modules comprises a plurality of steps, represented in FIG. 6.

In a step E1, a state of the system is defined via the programmer interface 31. Execution modules 3, 5, 7 and the portal module 11 are eventually activated. The communication links 9, 13, 15, 17 are also defined between these execution modules 3, 5, 7 and between each of the execution modules 3, 5, 7 and the portal module 11.

In a step E2, the operation rules R1, R2, R3 applicable to the execution modules 3, 5, 7 and to the portal module 11 are defined.

In a step E3, buttons 44, each corresponding to an interaction between the user and the configuration interface 19, are selected. The operation rules applicable to the buttons 44 are also defined.

In a step E4, the user programs are loaded toward the portal module 11 and the execution modules 3, 5, 7.

In a step E5, the entire system of execution modules executes the user macro-program.

Optionally, instead of steps E1, E2 and E3, in a step E1′, we connect to the system of execution modules, then we download at least one user program from the execution modules 3, 5, 7 and the portal module 11 toward the configuration interface 19. Optionally, it is possible for the user to modify the downloaded user program.

Optionally, in a step E6, subsequent to step E5, the user may carry out an interaction with the configuration interface 19 and more particularly with at least one of the interaction elements 44 of the control interface 37.

In a step E7, the operation corresponding to the interface interaction is carried out by the corresponding execution module 3, 5, 7 or the portal module 11, during the functioning of the system thanks to the virtual machine 51.

Of course, the present disclosure is not limited to the described and represented embodiment, given only but as an illustrative and non-limiting example.

1. A method for configuring a system of execution modules, interconnected, each of the execution modules of the system of execution modules including a virtual machine and at least one actuator and/or one sensor and/or one user interface and/or one data processing system, comprising the method including the following steps:
providing an configuration interface for configuring interconnected execution modules, indicating a nature of each of the execution modules, a state of each of the execution modules on the basis of a variable representative of a functioning state of the at least one execution module or a measurement of a physical quantity by a sensor of the at least one execution module, and at least one link between the execution modules;
providing at least one user macro-program comprising at least one user program;
defining at least one user program of the user macro-program executable on a determined execution module comprising at least one operation rule defining at least one operation to be carried out, the realization of said at least one operation corresponding to the generation of a control command toward an actuator and/or a user interface and/or a data processing system of this execution module, and/or toward at least one execution module of the system of interconnected execution modules; and
sending the at least one user program toward at least one determined execution module via at least one communication link, the at least one execution module being arranged so as to execute the user program.

2. The configuration method according to claim 1, wherein the operation is carried out based on at least one condition determined by a configuration interface or by a control command from at least one execution module of the system of execution modules on the basis of a value of the variable representative of a functioning state of at least one execution module of the system of execution modules, or of a measurement of a physical quantity by a sensor of at least one execution module.

3. The configuration method according to claim 2, wherein the at least one execution module is arranged so as to assess the realization of the at least one condition of the at least one operation rule based on the at least one value of the representative variable, and to carry out the at least one operation based on the assessment of the realization of the at least one condition.

4. The configuration method according to claim 1, wherein the at least one operation is carried out on receipt of local data or based on data from at least one execution module of the system of interconnected execution modules.

5. The configuration method according to claim 4, wherein the at least one execution module is arranged so as to assess the realization of the at least one operation by the data processing system.

6. The configuration method according to claim 1, comprising a step of defining a state of the system of execution modules, in which determined execution modules are activated and determined communication links are defined.

7. The configuration method according to claim 1, comprising at least one step of configuring a control interface in which the correspondence is defined between at least one interface interaction and the determination of the at least one condition and/or of the at least one operation.

8. The configuration method according to claim 7, comprising a step in which, subsequently to an interface interaction, a modified user program is sent toward the at least one execution module.

9. The configuration method according to claim 1, comprising a step of implementing a wireless communication thanks to a portal module between the configuration interface and the at least one execution module or still between two execution modules of the system of execution modules.

10. The configuration method according to claim 1, comprising a step of implementing a wireless connection thanks to a portal module between the system of execution modules and an external system of execution modules.

11. A method for controlling at least one execution module of a system of interconnected execution modules, the at least one execution module including at least one actuator and/or one sensor and/or one user interface and/or one data processing system, the method including the following steps:
providing at least one user program comprising at least one operation rule defining at least one operation to be carried out, the realization of said at least one operation corresponding to the generation of a control command toward an actuator and/or a user interface and/or a data processing system of this execution module, and/or toward at least one execution module of the system of interconnected execution modules; and then
executing the at least one user program.

12. The control method according to claim 11, wherein the operation is carried out based on at least one condition determined by a configuration interface or by a control command from at least one execution module of the system of execution modules on the basis of a value of the variable representative of a functioning state of at least one execution module of the system of execution modules, or of a measurement of a physical quantity by a sensor of at least one execution module.

13. The control method according to claim 12, wherein the step B includes the following substeps:
assessing the realization of the at least one condition of the at least one operation rule based on the at least one value of the representative variable; and then
carrying out the at least one operation based on the assessment of the realization of the at least one condition.

14. The control method according to claim 11, wherein the at least one operation is carried out on receipt of local data or based on data from at least one execution module of the system of interconnected execution modules.

15. The control method according to claim 11, wherein the at least one execution module is arranged so as to assess the realization of the at least one operation by the data processing system.

16. A system of interconnected execution modules including a multitude of execution modules, each comprising an electronic control unit, the system of interconnected execution modules further comprising:
at least one configuration interface arranged so as to define at least one user program including at least one operation rule,
at least one first execution module among the multitude of execution modules arranged so as to interpret and execute the at least one user program,
at least one second execution module among the multitude of execution modules arranged so as to communicate with the at least one first module via a communication interface,
the at least one operation rule defining at least one operation to be carried out, and
the realization of said at least one operation corresponding to the generation of a control command toward the at least one first execution module and/or the at least one second execution module.

17. The system of interconnected execution modules according to claim 16, wherein the operation is carried out based on at least one condition determined on the basis of the variable representative of a functioning state or of a measurement of a physical quantity by a sensor of the at least one first and/or the at least one second execution module among the multitude of execution modules.

18. The system of execution modules according to claim 16, comprising a portal module allowing sending and/or receiving data toward and/or from the system of execution modules.
